(19) United States
(12) Patent Application Publication
(10) Pub. No.: US 2009/0045718 A1
(43) Pub. Date: Feb. 19, 2009

(54) After-Glowing Lamp

(75) Inventors: Frank Auer, Herbrechtingen-Bolheim (DE); Oliver Hering, Niederstotzingen (DE); Marc Lunnemann, Gerstetten (DE)

Correspondence Address: OSRAM SYLVANIA INC, 100 ENDICOTT STREET, DANVERS, MA, 01923, US

(73) Assignee: Osram Gesellschaft MIT Beschrankter Haftung, Munchen (DE)

(21) Appl. No.: 12/223,470

(22) PCT Filed: Jan. 29, 2007
(86) PCT No.: PCT/EP2007/050825

§ 371 Date: Jul. 31, 2008

(30) Foreign Application Priority Data
Feb. 1, 2006 (DE) 10 2006 004 977.2

(51) Int. Cl. H01J 1/62

(52) U.S. Cl. 313/483

(57) ABSTRACT

Disclosed is a lamp (1) comprising at least one bulb which is inserted into a base and inside which at least one illuminant (18) is accommodated. The inventive lamp (1) encompasses at least one area (44) which continues glowing once the illuminant has been turned off.

### I. TECHNICAL FIELD

The invention relates to a lamp with at least one lamp vessel, which is inserted into a base and in which at least one luminous means is accommodated.

### II. PRIOR ART

In order to design a headlamp in such a way that it has an afterglow, a luminous ring made from plastic provided with phosphorescent substances is described, for example, on the website www.eufab.de under the product designation “Fluor Magic Ring” [fluorescent magic ring]. This is obtainable as an accessory in addition to the headlamp and is pushed onto the base of the lamp over the lamp vessel at the end and fixed on the lamp by means of projections engaging in cutouts in the base. The lamp's radiation is energetically applied to the phosphorescent substances of the luminous ring during operation of the lamp, with the result that the luminous ring continues to glow for several minutes up to hours after the lamp has been switched off and forms a homogeneous luminous surface, which is visible in a dark environment and produces an esthetically appealing optical effect, for example in a vehicle headlamp. In addition, the operational reliability of the lamp can be checked, in particular in the case of a vehicle lamp, since the luminous ring only continues to glow in the dark once it has been irradiated by the lamp.

One disadvantage with such lamps which are provided with an additional luminous ring is that, owing to the homogeneous luminous surface of the ring, they do not provide any possibilities as regards information and a second disadvantage is that additional complexity in terms of fitting is required in order to fit the luminous ring on the lamp. Furthermore, it is disadvantageous that the luminous ring can become detached from the base of the lamp and can come into contact with the lamp vessel which is subjected to a high thermal load and can result in failure of the lamp and, as a result, in a safety risk.

### III. DESCRIPTION OF THE INVENTION

The invention is based on the object of providing a lamp in which an afterglow effect with possibilities in terms of information and with minimum complexity in terms of the apparatus is possible in comparison with conventional solutions.

This object is achieved according to the invention by a lamp with at least one lamp vessel, which is inserted into the base and in which at least one luminous means is accommodated, the lamp having at least one region which continues to glow once the luminous means has been switched off.

The lamp according to the invention has at least one lamp vessel, which is inserted into a base and in which at least one luminous means is accommodated. According to the invention, the lamp has at least one region which continues to glow once the luminous means has been switched off. With this solution, as a result of the afterglow region of the lamp, it is possible to dispense with an additional afterglow ring in comparison with the prior art, with the result that the lamp according to the invention allows for an afterglow effect with minimum complexity in terms of apparatus. The afterglow region provided on the lamp also makes it possible for information to be provided on the manufacturer, the lamp type or the like in addition to making it possible for a functional check of the lamp to be carried out.

In accordance with a particularly preferred exemplary embodiment of the invention, the afterglow region is in the form of an inscription or graphic, for example in the form of a brand logo (branding). The direct link between a lamp, for example a vehicle lamp or a general lighting lamp, and an afterglow region makes it possible to provide the lamp with a graphic or with inscriptions which are visible in particular once the luminous means has been switched off in a dark environment.

The afterglow region preferably has at least one phosphorescent substance. One advantage of phosphorescent substances consists in the fact that, depending on the composition, they can emit light with a different wavelength than the light with which they are irradiated. As a result, the phosphorescent substance can be designed in such a way that, once the luminous means has been switched off, light in the desired color range is emitted.

In a first exemplary embodiment, the afterglow region is applied to the lamp as a coating. The afterglow time, afterglow intensity and afterglow color can in this case be altered in a defined manner by the coating materials and the composition of the coating.

The afterglow coating is preferably applied to at least one visible surface of the base. Since the base is subjected to less thermal loading than the lamp vessel, a long life of the afterglow coating is achieved.

It has proven to be particularly advantageous if the afterglow coating is applied to the lamp by means of a printing process, for example by means of offset printing. In this case, a phosphorescent substance is preferably dispersed in a silicone compound and then printed onto the base of the lamp, for example, by means of a printing operation.

In one variant of the lamp according to the invention, the base has at least one cutout, which delimits the afterglow region, an afterglow molding, at least sections of which are matched to the inner contour of the lamp base, being fixed in the base. The molding is preferably fixed in the base by means of an adhesive-bonding and/or clamping technique.

In this alternative embodiment of the invention, the cutout which delimits the afterglow region is preferably introduced into the base by means of laser irradiation or stamping, for example in the form of an inscription or a graphic.

The molding is preferably made from plastic, which contains at least one phosphorescent substance, in particular made from a phosphorescent silicone casting compound, or from a plastic, at least sections of which are coated with a phosphorescent material.

In accordance with a further variant of the invention, the base of the lamp is formed from a plastic, the afterglow region being introduced into the base in a multi-component injection-molding process.

### IV. BRIEF DESCRIPTION OF THE DRAWINGS

The invention will be explained in more detail below with reference to preferred exemplary embodiments. In the drawings:

FIG. 1 shows a three-dimensional illustration of a lamp according to the invention in accordance with a first exemplary embodiment, and

FIG. 2 shows a three-dimensional illustration of a positioning ring of a lamp according to the invention in accordance with a second exemplary embodiment.

### V. DESCRIPTION OF THE PREFERRED EXEMPLARY EMBODIMENT

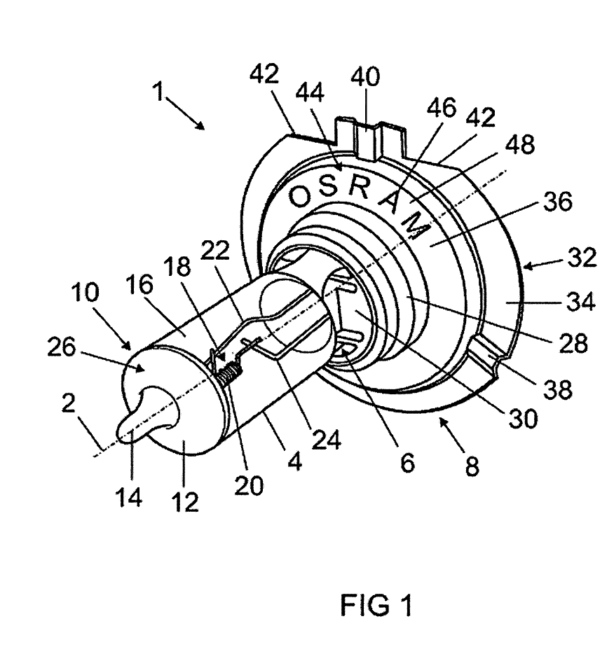

FIG. 1 shows a three-dimensional illustration of a lamp according to the invention 1 with a substantially cylindrical lamp vessel 4, which is made from hard glass, is rotationally symmetrical around a lamp longitudinal axis 2, is sealed via a pinch seal 6 and is inserted into a base 8 of the type PX 26d, via which the lamp 1 can be inserted into a lampholder (not illustrated) of a vehicle headlamp. The end section 10 of the lamp vessel 4 which is remote from the base 8 is formed by a ball-shaped dome 12, which has a centrally arranged exhaust stem 14, to which an exhaust tube has been attached during production of the lamp 1, in order to evacuate the interior of the lamp vessel 4 and to fill it with a filling gas containing halogens. After the filling operation, the exhaust tube is removed and the exhaust stem attachment is fused closed. Accommodated in an interior 16 of the lamp vessel 4 is a luminous means 18, which, in the exemplary embodiment illustrated, is configured as an incandescent filament 20, which is arranged in the axial direction and is held in the lamp vessel 4 via two power supply wires 22, 24. The outer end sections of the power supply wires 22, 24 are connected to in each case one contact lug (not illustrated) for supplying voltage to the incandescent filament 20. As a result of the axial arrangement of the incandescent filament, the undesired emission into the lamp neck is minimized in comparison with a horizontal arrangement of the incandescent filament 20 and, as a result, the optical efficiency of the lamp 1 is improved. The dome 12 of the lamp vessel 4 is provided around the periphery with a silver-colored covering coating 26, which reflects radiation, which has been emitted axially parallel with respect to the lamp longitudinal axis 2 by the incandescent filament 20, back onto the reflector of the headlamp (not illustrated). As a result, the efficiency of the lamp 1 is improved and a glare effect as a result of radiation emitted directly from the incandescent filament 20 is avoided. As a result of the covering coating 26, the lamp 1 with the likewise silver-colored reflector in the background furthermore forms an optically virtually perfect unit of high esthetic quality.

In the exemplary embodiment shown, the base 8 of the lamp is in the form of a plate-like base and substantially comprises an approximately cylindrical base sleeve 28, into which the lamp vessel 4 is inserted via the pinch seal 6 and is fixed in clamping fashion by means of fastening tabs 30 and a positioning ring 32, via which the lamp 1 can be inserted in the correct position into the lampholder of the headlamp. The positioning ring 32 is in the form of a graduated stamped and bent sheet-metal part with a cross section which is circular in sections and is connected to the base sleeve 28 via an approximately L-shaped fastening element 36. The positioning ring 32 has a plate-like flange 34, into which three impressions 38, 40 (one of the impressions 38 is hidden by the lamp vessel 4) are introduced, which impressions are arranged offset with respect to one another and make it possible to fit the lamp 1 in the lampholder in a defined manner. For this purpose, the impressions 38 are arranged offset through 90° with respect to one another and through 135° with respect to the third impression 40. The region of the third impression 40 is delimited by two notches 42 in the plate-like flange 34 of the base 8, which notches make it possible to ventilate the headlamp interior (not illustrated).

According to the invention, the lamp 1 has a region 44 which continues to glow once the luminous means 18 has been switched off and, in the exemplary embodiment shown, has a phosphorescent substance, which is applied as a coating 46 in the form of an inscription to a visible surface 48 of the base 8 and is visible in particular once the luminous means 18 has been switched off in a dark environment, the afterglow color, afterglow time and afterglow intensity being determined by the coating materials and the composition of the coating 46. It has proven to be particularly advantageous if the afterglow coating 46 is applied by means of a printing process, for example by means of offset printing. In this case, the phosphorescent substance is, for example, dispersed in a silicone casting compound and then printed onto the visible surface 48 of the lamp base 8 by means of a printing operation.

In one variant of the lamp 1 which is not illustrated, the base 8 has a cutout, which is introduced into the visible surface 48 of the plate-like flange 34, for example by means of laser irradiation in the form of an inscription, and delimits the afterglow region 44, an afterglow molding, for example one made from a phosphorescent silicone casting compound or a molding provided with a phosphorescent coating, at least sections of which afterglow molding are matched to the inner contour of the lamp base 8, is inserted at the rear into the positioning ring 32 and fixed therein by means of clamping or adhesive-bonding.

In a further variant of the invention which is not illustrated, a plastic base is used. In this solution, the afterglow region 44 is introduced into the base in a multi-component injection-molding process.

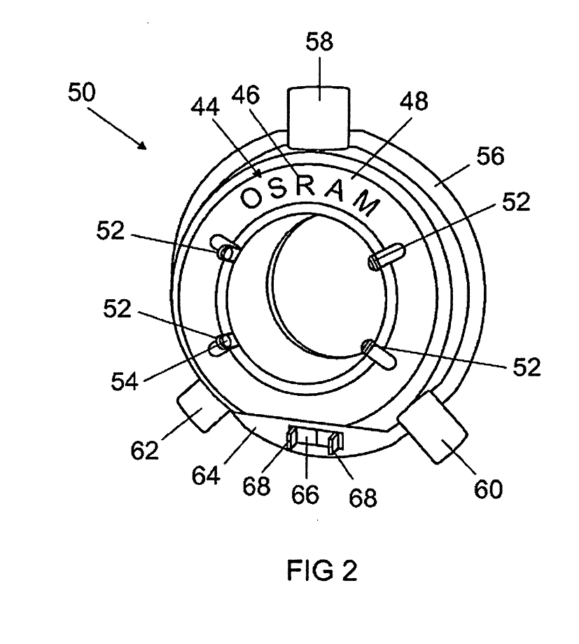

FIG. 2 illustrates a positioning ring 50 of a lamp according to the invention in accordance with a second exemplary embodiment. This exemplary embodiment differs from the previously described exemplary embodiment substantially in that the positioning ring 50, for the purpose of fastening to the outer circumferential surface of the base sleeve (not illustrated), has four holding tabs 52, which are arranged offset with respect to one another, are stamped free from the base 8 and extend substantially in the longitudinal direction of the base 8. Radially inwardly extending knobs 54, which are used as weld points for fastening the positioning ring 50 on the base sleeve, are introduced on the holding tabs 52. The positioning ring 50 is in the form of a graduated stamped and bent sheet-metal part with a cross section which is circular in sections, three positioning tabs 58, 60, 62, which are arranged offset with respect to one another and make it possible to fit the lamp 1 in the lampholder in a defined manner, being formed on a plate-like flange 56. The positioning ring 50 furthermore has a step-like protrusion 64, into which an approximately rectangular ventilation opening 66, which has been stamped free from the step-like protrusion 64, for ventilating the headlamp interior (not illustrated) is introduced, which ventilation opening is delimited by two stamped tabs 68, which extend substantially in the longitudinal direction of the positioning ring 50. As has already been explained, an afterglow coating 46 made from a phosphorescent substance in the form of an inscription is applied to the visible surface 48 of the positioning ring 50 and is visible in particular once the lamp has been switched off in a dark environment.

The lamp 1 according to the invention is not restricted to the lamp and base types described for vehicle headlamps, but the invention can also be used with different lamp and base types known from the prior art, in particular in lamps for general lighting. Furthermore, the afterglow coating 46 can be applied to the lamp vessel 4, for example in the region of the dome 12, or to a reflector (not illustrated) of the lamp 1. In particular in the case of lamps for general lighting, the afterglow coating 46 can be in the form of, for example, an inscription or brand logo which is arranged on the outer surface of the lamp vessel, for example in the region of the dome of the lamp vessel.

The invention discloses a lamp 1 with at least one lamp vessel 4, which is inserted into a base 8 and in which at least one luminous means 18 is accommodated. According to the invention, the lamp 1 has at least one region 44 which continues to glow once the luminous means 18 has been switched off.

### LIST OF REFERENCE SYMBOLS

1 Lamp
2 Lamp longitudinal axis
4 Lamp vessel
6 Pinch seal
8 Base
10 End section
12 Dome
14 Exhaust stem
16 Interior
18 Luminous means
20 Incandescent filament
22 Power supply wire
24 Power supply wire
26 Covering coating
28 Base sleeve
30 Fastening tab
32 Positioning ring
34 Plate-like flange
36 Fastening element
38 Impression
40 Impression
42 Notch
44 Region
46 Coating
48 Visible surface
50 Positioning ring
52 Holding tab
54 Knob
56 Plate-like flange
58 Positioning tab
60 Positioning tab
62 Positioning tab
64 Step-like protrusion
66 Ventilation opening
68 Stamped tab

1. A lamp with at least one lamp vessel (4), which is inserted into a base (8) and in which at least one luminous means (18) is accommodated, characterized in that the lamp (1) has at least one region (44) which continues to glow once the luminous means (18) has been switched off.

2. The lamp as claimed in claim 1, the afterglow region (44) is an inscription and/or a graphic, in particular a brand logo.

3. The lamp as claimed in claim 1, the afterglow region (44) having at least one phosphorescent substance.

4. The lamp as claimed in claim 1, the afterglow region (44) being applied to the lamp (1) as a coating (46).

5. The lamp as claimed in claim 4, the afterglow coating (46) being applied to at least one visible surface (48) of the base (8).

6. The lamp as claimed in claim 4, the afterglow coating (46) being applied by means of a printing process, in particular by means of offset printing.

7. The lamp as claimed in claim 1, the base having at least one cutout, which delimits the afterglow region (44), and an afterglow molding, at least sections of which are matched to the inner contour of the lamp base, is arranged in the base.

8. The lamp as claimed in claim 7, the molding being made from plastic with at least one phosphorescent substance, in particular phosphorescent silicone casting compound.

9. The lamp as claimed in claim 7, at least sections of the molding being coated with a phosphorescent material.

10. The lamp as claimed in claim 7, the molding being fixed in the base by means of an adhesive-bonding and/or clamping technique.

11. The lamp as claimed in claim 7, the cutouts which delimit the afterglow region (44) being introduced into the base by means of laser irradiation or stamping.

12. The lamp as claimed in claim 1, the base of the lamp being made from a plastic, and the afterglow region (44) being introduced into the base in a multi-component injection-molding process.

13. The lamp as claimed in claim 1, the afterglow region (44) being arranged on the lamp vessel (4).

14. The lamp as claimed in claim 2, the afterglow region (44) having at least one phosphorescent substance.

15. The lamp as claimed in claim 3, the afterglow region (44) being applied to the lamp (1) as a coating (46).

16. The lamp as claimed in claim 5, the afterglow coating (46) being applied by means of a printing process, in particular by means of offset printing.

17. The lamp as claimed in claim 3, the base having at least one cutout, which delimits the afterglow region (44), and an afterglow molding, at least sections of which are matched to the inner contour of the lamp base, is arranged in the base.

18. The lamp as claimed in claim 8, the molding being fixed in the base by means of an adhesive-bonding and/or clamping technique.

19. The lamp as claimed in claim 8, the cutouts which delimit the afterglow region (44) being introduced into the base by means of laser irradiation or stamping.

20. The lamp as claimed in claim 3, the base of the lamp being made from a plastic, and the afterglow region (44) being introduced into the base in a multi-component injection-molding process.
